(19) United States
(12) Patent Application Publication
(10) Pub. No.: US 2015/0302056 A1
(43) Pub. Date: Oct. 22, 2015

(54) METHOD, SYSTEM, AND STORAGE MEDIUM FOR INFORMATION SEARCH

(71) Applicant: Tencent Technology (Shenzhen) Company Limited, Guangdong (CN)

(72) Inventors: Xiang HE, Guangdong (CN); Chao Qi, Guangdong (CN); Jianqun Chen, Guangdong (CN); Ye Wang, Guangdong (CN); Feng Jiao, Guangdong (CN); Yuekui Yang, Guangdong (CN)

(21) Appl. No.: 14/413,239

(22) PCT Filed: Sep. 11, 2013
(86) PCT No.: PCT/CN2013/083321

§ 371 Date: May 15, 2015

(30) Foreign Application Priority Data
Sep. 13, 2012 (CN) 201210336551.6

(51) Int. Cl. G06F 17/30

(52) U.S. Cl. CPC G06F 17/30442; G06F 17/30867; G06F 17/30528

(57) ABSTRACT

The present invention relates to a method, system, and storage medium for information search. The method for information search comprises: receiving an information search string inputted by a user; determining whether or not the information search string inputted by the user is complete, if the information search string inputted by the user is incomplete, then helping the user in completing the information search string; and, performing a search on the basis of the completed information search string. The method and system for information search of embodiments of the present invention combine user search history and user scenario to understand the intent of the user, to help the user in completing search information, to allow for searches of increased convenience and speed, and to increase the operability of the searches.

### CROSS REFERENCE TO RELATED APPLICATIONS

The present application claims the benefit of priority to China Patent Application No. 201210336551.6 filed in the Chinese Patent Office on Sep. 13, 2012, and entitled “METHOD, SYSTEM AND STORAGE MEDIUM FOR INFORMATION SEARCH”, the content of which is hereby incorporated by reference in its entirety.

### FIELD

The disclosure relates to the field of Internet technology, and particularly to a method, a system, and a storage medium for information search.

### BACKGROUND

This section provides background information related to the present disclosure which is not necessarily prior art.

With the continuous development of the Internet business, a search engine has become an indispensable and important tool in people's daily work and life. The search engine can obtain information of each website from the Internet, and search records that are matched with a search string inputted by a user, and return results according to a certain order. The typical search engines include Baidu, Google and so on. However, the existing search engine has the following disadvantages: a search is performed only based on a current search string inputted by the user, which cannot combine the context to understand the intent of the user. In addition, the existing search engines may perform a search according to any search term inputted by the user, when search information is missing, it cannot prompt the user to complete the search information according to the characteristics of a search task.

### SUMMARY

Exemplary embodiments of the present invention provide a method, a system, and a storage medium for information search, which are directed to solve the problem in the existing technology that a search is performed only based on a current search string inputted by a user, but cannot understand the intent of the user and prompt the user to complete search information.

According to a first aspect of the present invention, it is provided a method for information search, including: receiving an information search string inputted by a user; determining whether or not the information search string inputted by the user is complete, if the information search string inputted by the user is incomplete, then helping the user in completing the information search string; and performing a search on the basis of a completed information search string.

According to a second aspect of the present invention, it is provided a system for information search, including: an information receiving module, which is configured to receive an information search string inputted by a user; an information completing module, which is configured to determine whether or not the information search string inputted by the user is complete, if the information search string inputted by the user is incomplete, helping the user in completing the information search string; and an information searching module, which is configured to perform a search on the basis of a completed information search string.

According to a third aspect of the present invention, it is provided a storage medium for information search, including: receiving an information search string inputted by a user; determining whether or not the information search string inputted by the user is complete, if the information search string inputted by the user is incomplete, then helping the user in completing the information search string; and performing a search on the basis of a completed information search string.

Exemplary embodiments of the present invention may have the following benefit effects.

The method and system for information search of embodiments of the present disclosure combine user search history and user scenario to understand the intent of the user, to help the user in completing search information, to allow for searches of increased convenience and speed, and to increase the operability of the searches. In addition, the method and system for information search of embodiments of the present disclosure can establish databases of corresponding field knowledge according to different tasks, and can provide a solution for analyzing the information search of a user, interacting with the user, and then completing the search task according to the databases of corresponding field knowledge.

### BRIEF DESCRIPTION OF THE DRAWINGS

In order to illustrate the embodiments or existing technical solutions more clearly, a brief description of drawings that assists the description of embodiments of the invention or existing art will be provided below. It would be apparent that the drawings in the following description are only for some of the embodiments of the invention. A person having ordinary skills in the art will be able to obtain other drawings on the basis of these drawings without paying any creative work.

FIG. 1 is a flowchart of a method for information search according to one embodiment of the invention;

FIG. 2 is a flowchart of a method for information search according to another embodiment of the invention;

FIG. 3 is a structure diagram of a system for information search according to yet another embodiment of the invention;

FIG. 4 is a structure diagram of a system for information search according to yet another embodiment of the invention.

### DETAILED DESCRIPTION OF ILLUSTRATED EMBODIMENTS

The following in conjunction with the accompanying drawings according to various embodiments, clearly describes technical proposals according to various embodiments. It would be obvious that the described embodiments are part but not all of embodiments. All other embodiments obtained by persons having ordinary skills without paying any creative work based on the illustrated embodiments should all be within the protection scope according to various embodiments.

Further descriptions of embodiments of the present invention in conjunction with the accompanying drawings will be illustrated in detail as below.

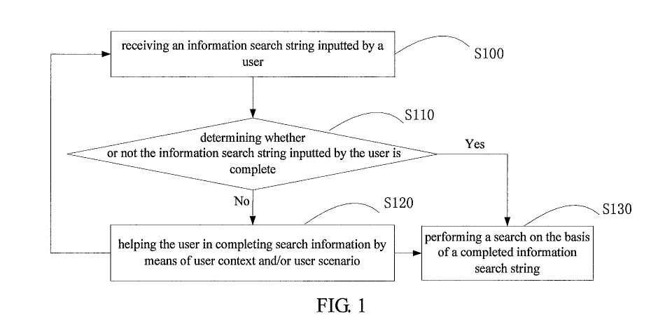

FIG. 1 is a flowchart of a method for information search according to one embodiment of the invention. As shown in FIG. 1, the method for information search includes the following steps.

Step S100: receiving an information search string inputted by a user.

In the step S100, the information search string inputted by the user may be a single word, phrase or sentence, may also be multiple words, phrases or sentences.

Step S110: determining whether or not the information search string inputted by the user is complete, if the information search string inputted by the user is incomplete, then performing step S120, and if the information search string inputted by the user is complete, then performing step S130.

In the step S110, the way of determining whether or not the information search string inputted by the user is complete can be realized on the basis that whether or not a search result can be searched from a database based on the information search string inputted by the user, or on the basis of the number of occurrences of the search results, or on basis of the information search string which have performed historical searches for the similar information. It should be understood that, the way of determining whether or not the information search string inputted by the user is complete is not only limited to the methods described above.

Step S120: helping the user in completing search information by means of user context and/or user scenario, and returning to the step S100.

In the step S120, the user context includes user search histories, user search records and related search records corresponding to the similar information of other users, and the intent of the user can be understood by means of multiple man-machine interaction. The user scenario may include: locations of the user, time, user interest, etc. The way of helping the user in completing the search information can automatically help the user in completing the information search string, or return prompt information to the user so as to let the user complete the information search string.

For example: inputted search information by a user is lack of the departure station (Beijing), thereby completing the inputted search information by means of a user scenario (the user in Beijing);

the information search string inputted by the user is: train ticket to Shanghai;

a completed search information according to the user scenario is: trains from Beijing to Shanghai.

| Train number | departure station | destination station |
|---|---|---|
| G101 | (Beijing South) | (Shanghai Hongqiao) |
| G105 | (Beijing South) | (Shanghai Hongqiao) |
| D365 | (Beijing South) | (Shanghai Hongqiao) |

For another example, inputted search information by a user is lack of the departure station and the destination station, thereby completing the inputted search information by means of a user context and a conversational mode;

the information search string inputted by the user is: where is the airplane?

a completed search information according to the user context and the conversational mode is: the air tickets from Beijing to Shanghai.

| | | | |
|---|---|---|---|
| HU7605 | 08:30-10:50 | 589 | 48% off |
| HU7607 | 09:05-11:15 | 590 | 48% off |
| CZ3907 | 08:40-10:50 | 605 | 46% off |

Step S130: performing a search on the basis of a completed information search string.

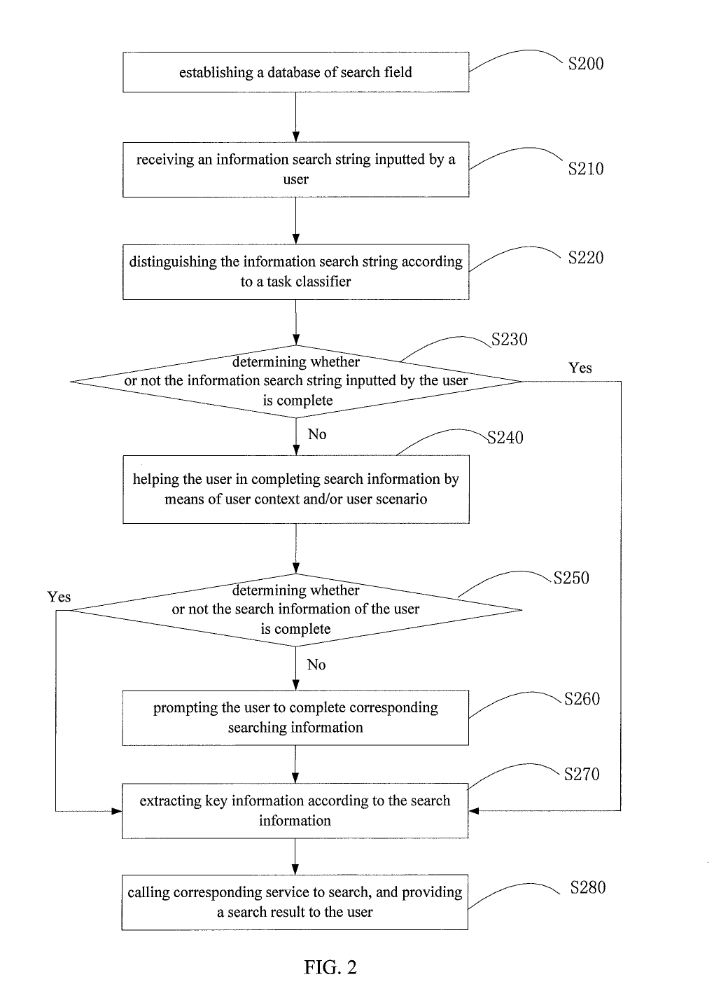

FIG. 2 is a flowchart of a method for information search according to another embodiment of the invention. As shown in FIG. 2, the method for information search includes the following steps.

Step S200: establishing a database of search field.

In the step S200, wherein the step of establishing the database of search field includes the following steps: establishing keywords of different search fields; obtaining a common search corpus of a search task; and extracting common sentence patterns according to the search corpus.

For example, the database of search field can be established corresponding to different tasks such as train tickets, flights, buses, etc. A search task for train tickets will be described as an example in the following. It should be understood that, the method for information search in embodiments of the present invention is not only limited to the fields described above.

The step of establishing a database of search train, includes:

step a: establishing keywords related to train search information, for example, it is necessary to establish the keywords such as the train station, train numbers, and the like for searching train search information;

step b: obtaining a common search corpus of the train search information. For example, the common search corpuses of the train search information, include:

how much is the train ticket from Beijing to Shanghai?

is there a train from Shanghai to Lhasa?

how long will the train T27 from Beijing to Lhasa drive?

when will the train T27 depart?

how much is the train T27 fare?

step c: summarizing common sentence patterns according to the search corpus; such as, the common sentence patterns of the train search information, include:

from A to B+the keywords such as trains, tickets, etc.

train number+the keywords such as fare, departure, etc.

Step S210: receiving an information search string inputted by a user.

In the step S210, the information search string inputted by a user may be a single word, phrase or sentence, may also be multiple words, phrases or sentences.

Step S220: distinguishing the information search string according to a task classifier.

In the step S220, the task classifier is configured to distinguish specific field of the information search string. For example, the information search string may belong to train, flight, bus information, restaurant information or other fields.

Step S230: determining whether or not the information search string inputted by the user is complete, if the information search string inputted by the user is incomplete, then performing step S240, and if the information search string inputted by the user is complete, then performing step S270.

In the step S230, the way of determining whether or not the information search string inputted by the user is complete can be realized on the basis that whether or not a search result can be searched from a database based on the information search string inputted by the user, or on the basis of the number of occurrences of the search results, or on the basis of the information search strings which have performed historical searches for the similar information. It should be understood that, the way of determining whether or not the information search string inputted by the user is complete is not only limited to the methods described above.

Step S240: helping the user in completing search information by means of user context and/or user scenario.

In the step S240, the user context includes user search histories, user search records and related search records corresponding to the similar information of other users, and the intent of the user can be understood by means of multiple man-machine interaction. The user scenario may include locations of the user, time, user interest, etc. The way of helping the user in completing the search information can automatically help the user in completing the information search string, or return prompt information to the user so as to let the user complete the information search string.

For example: inputted search information by a user is lack of the departure station (Beijing), thereby completing the inputted search information by means of a user scenario (the user in Beijing);

the information search string inputted by the user is: train ticket to Shanghai;

a completed search information according to the user scenario is: trains from Beijing to Shanghai.

| Train number | departure station | destination station |
|---|---|---|
| G101 | (Beijing South) | (Shanghai Hongqiao) |
| G105 | (Beijing South) | (Shanghai Hongqiao) |
| D365 | (Beijing South) | (Shanghai Hongqiao) |

For another example, inputted search information by a user is lack of the departure station and the destination station, thereby completing the inputted search information by means of a user context and a conversational mode;

the information search string inputted by the user is: where is the airplane?

a completed searching information according to the user context and the conversational mode is: the air tickets from Beijing to Shanghai.

| | | | |
|---|---|---|---|
| HU7605 | 08:30-10:50 | 589 | 48% off |
| HU7607 | 09:05-11:15 | 590 | 48% off |
| CZ3907 | 08:40-10:50 | 605 | 46% off |

Step S250: determining whether or not the search information of the user is complete, if the search information of the user is incomplete, then performing step S260, and if the search information of the user is complete, then performing step S270.

Step S260: prompting the user to complete corresponding search information.

In the step S260, the way of prompting the user to complete the corresponding search information can be realized by means of returning the information which needs to be completed, or returning multiple search information to allow the user to choose.

For example, the information search string inputted by the user is: train tickets from Beijing;

returning prompt information: whether or not to forget to input the destination?

Step S270: extracting key information according to the search information.

Step S280: calling corresponding service to search, and providing a search result to the user.

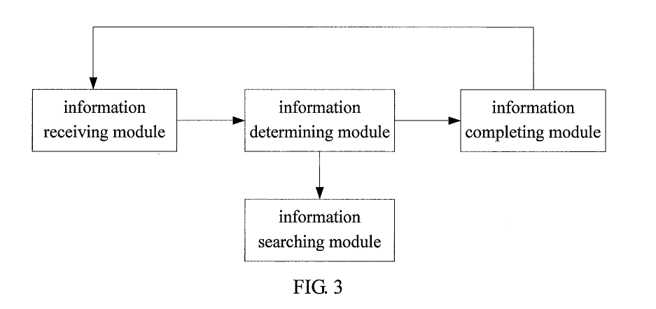

FIG. 3 is a structure diagram of a system for information search according to yet another embodiment of the invention. As shown in FIG. 3, the system for information search includes an information receiving module, an information determining module, an information completing module and an information searching module.

The information receiving module, is configured to receive an information search string inputted by a user. Wherein the information search string inputted by the user may be a single word, phrase or sentence, may also be multiple words, phrases or sentences.

The information determining module, is configured to determine whether or not the information search string inputted by the user is complete, if the information search string inputted by the user is incomplete, helping the user in completing search information by the information completing module, and if the information search string inputted by the user is complete, performing a search by the information searching module.

The information completing module, is configured to help the user in completing the information search string by means of user context and/or user scenario. Wherein the user context includes user search histories, user search records and related search records corresponding to the similar information of other users, and the intent of the user can be understood by means of multiple man-machine interaction. The user scenario may include locations of the user, time, user interest, etc. The way of helping the user in completing the search information can automatically help the user in completing the information search string, or return prompt information to the user so as to let the user complete the information search string.

For example: inputted search information by a user is lack of the departure station (Beijing), thereby completing the inputted search information by means of a user scenario (the user in Beijing);

the information search string inputted by the user is: train ticket to Shanghai;

a completed searching information according to the user scenario is: trains from Beijing to Shanghai.

| Train number | departure station | destination station |
|---|---|---|
| G101 | (Beijing South) | (Shanghai Hongqiao) |
| G105 | (Beijing South) | (Shanghai Hongqiao) |
| D365 | (Beijing South) | (Shanghai Hongqiao) |

For another example, inputted search information by a user is lack of the departure station and the destination station, thereby completing the inputted search information by means of a user context and a conversational mode;

the information search string inputted by the user is: where is the airplane?

a completed searching information according to the user context and the conversational mode is the air tickets from Beijing to Shanghai.

| | | | |
|---|---|---|---|
| HU7605 | 08:30-10:50 | 589 | 48% off |
| HU7607 | 09:05-11:15 | 590 | 48% off |
| CZ3907 | 08:40-10:50 | 605 | 46% off |

The information searching module is configured to perform a search on the basis of the information search string inputted by the user.

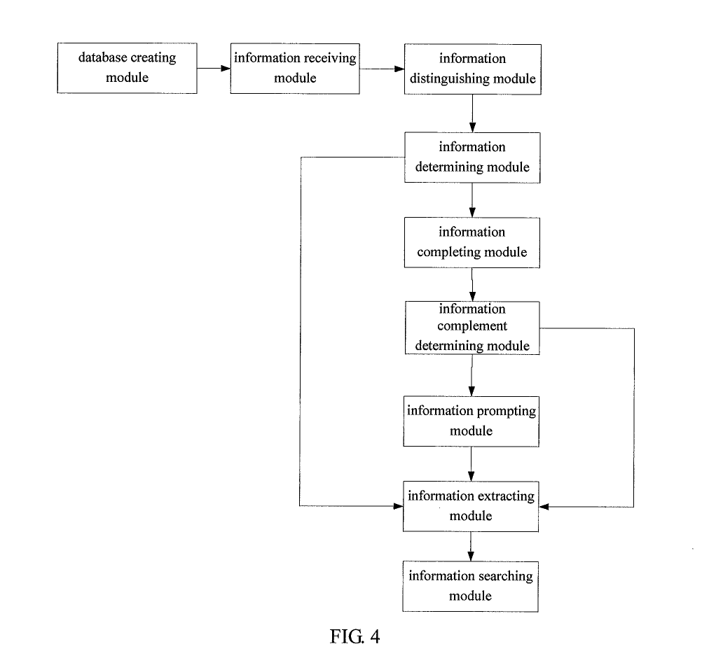

FIG. 4 is a structure diagram of a system for information search according to yet another embodiment of the invention. As shown in FIG. 4, the system for information search includes a database establishing module, an information receiving module, an information distinguishing module, an information determining module, an information completing module, an information complement determining module, an information prompting module, an information extracting module and an information searching module.

The database establishing module is configured to establish a database of search field. Wherein the database establishing module establishing the database of search field is by: establishing keywords of different search fields; obtaining a common search corpus of a search task; and extracting a common sentence pattern according to the search corpus.

For example, the database of search field can be established corresponding to different tasks such as train tickets, flights, buses, etc. A search task for train tickets will be described as an example in the following. It should be understood that, the method for information search in embodiments of the present invention is not only limited to the fields described above.

Establishing a database of search train by the database establishing module, includes:

step a: establishing keywords related to train search information, for example, it is necessary to establish the keywords such as the train station, train numbers, and the like for searching train search information;

step b: obtaining a common search corpus of the train search information. For example, the common search corpuses of the train search information include:

how much is the train ticket from Beijing to Shanghai?

is there a train from Shanghai to Lhasa?

how long will the train T27 from Beijing to Lhasa drive?

when will the train T27 depart?

how much is the train T27 fare?

step c: summarizing common sentence patterns according to the search corpus; such as, the common sentence patterns of the train search information, include:

from A to B+the keywords such as trains, tickets, etc.

train number+the keywords such as fare, departure, etc.

The information distinguishing module, is configured to distinguish a received information search string according to a task classifier. Wherein the task classifier is configured to distinguish specific field of the information search string. For example, the information search string may belong to train, flight, bus information, restaurant information or other fields.

The information determining module, is configured to determine whether or not the information search string inputted by the user is complete, if the information search string inputted by the user is incomplete, helping the user in completing search information by the information completing module, and if the information search string inputted by the user is complete, extracting key information by the information extracting module. Wherein the information determining module can determine whether or not the information search string inputted by the user is complete on the basis that whether or not a search result can be searched from a database based on the information search string inputted by the user, or on the basis of the number of occurrences of the search results, or on the basis of the information search strings which have performed historical searches for the similar information. It should be understood that, the way of determining whether or not the information search string inputted by the user is complete is not only limited to the methods described above.

The information completing module, is configured to help the user in completing the search information of the user by means of user context and/or user scenario. Wherein the user context includes user search histories, user search records and related search records corresponding to the similar information of other users, and the intent of the user can be understood by means of multiple man-machine dialogue. The user scenario may include locations of the user, time, user interest, etc. The way of helping the user in completing the search information can automatically help the user in completing the information search string, or return prompt information to the user so as to let the user complete the information search string.

For example: inputted search information by a user is lack of the departure station (Beijing), thereby completing the inputted search information by means of a user scenario (the user in Beijing);

the information search string inputted by the user is: train ticket to Shanghai.

a completed search information according to the user scenario is: trains from Beijing to Shanghai.

| Train number | departure station | destination station |
|---|---|---|
| G101 | (Beijing South) | (Shanghai Hongqiao) |
| G105 | (Beijing South) | (Shanghai Hongqiao) |
| D365 | (Beijing South) | (Shanghai Hongqiao) |

For another example, inputted search information by a user is lack of the departure station and the destination station, thereby completing the inputted search information by means of a user context and a conversational mode;

the information search string inputted by the user is: where is the airplane?

a completed searching information according to the user context and the conversational mode is: the air tickets from Beijing to Shanghai.

| | | | |
|---|---|---|---|
| HU7605 | 08:30-10:50 | 589 | 48% off |
| HU7607 | 09:05-11:15 | 590 | 48% off |
| CZ3907 | 08:40-10:50 | 605 | 46% off |

The information complement determining module, is configured to determine whether or not search information of the user is complete, if the search information of the user is incomplete, prompting the user to complete the search information by the information prompting module, and if the search information of the user is complete, extracting key information by the information extracting module.

The information prompting module, is configured to prompt the user to complete the search information. Wherein the information prompting module prompting the user to complete the corresponding search information can be realized by means of returning the information which needs to be completed, or returning multiple search information to allow the user to choose.

For example, the information search string inputted by the user is: train tickets from Beijing;

returning prompt information: whether or not to forget to input the destination?

The information extracting module is configured to extract key information according to the search information.

The information searching module is configured to call corresponding service to search and provide a search result to the user according to the information inputted by the user.

The method and system for information search of embodiments of the present disclosure combine user search history and user scenario to understand the intent of the user, to help the user in completing search information, to allow for searches of increased convenience and speed, and to increase the operability of the searches. In addition, the method and system for information search of embodiments of the present disclosure can establish databases of corresponding field knowledge according to different tasks, and can provide a solution for analyzing the information search of a user, interacting with the user, and then completing the search task according to the databases of corresponding field knowledge.

A person having ordinary skills in the art can realize that part or whole of the processes in the methods according to the above embodiments may be implemented by a computer program instructing relevant hardware. The program may be stored in a computer readable storage medium. When executed, the program may execute processes in the above-mentioned embodiments of methods. The storage medium may be a magnetic disk, an optical disk, a Read-Only Memory (ROM), a Random Access Memory (RAM), et al.

The foregoing descriptions are merely exemplary embodiments of the present invention, but not intended to limit the protection scope of the present invention. Any variation or replacement made by persons of ordinary skills in the art without departing from the spirit of the present invention shall fall within the protection scope of the present invention. Therefore, the scope of the present invention shall be subject to be appended claims.

What is claimed is:

1. A method for information search, comprising the steps of:
receiving an information search string inputted by a user;
determining whether or not the information search string inputted by the user is complete, if the information search string inputted by the user is incomplete, then helping the user in completing the information search string; and
performing a search on the basis of a completed information search string.

2. The method for information search according to claim 1, wherein helping the user in completing the information search string comprises: helping the user in completing the information search string by means of user context and/or user scenario.

3. The method for information search according to claim 2, wherein the user context comprises user search histories, user search records and related search records to similar information of other users; wherein the user scenario comprises a location of the user, time, and/or user interest.

4. The method for information search according to claim 2, before the step of receiving the information search string inputted by the user, the method further comprising: establishing a database of search field.

5. The method for information search according to claim 4, wherein establishing the database of search field comprises: establishing keywords of different search fields; obtaining a common search corpus of a search task; and extracting a common sentence pattern according to the search corpus.

6. The method for information search according to claim 2, after the step of receiving the information search string inputted by the user, the method further comprising: distinguishing a received information search string according to a task classifier.

7. The method for information search according to claim 1, after the step of helping the user in completing the information search string, the method further comprising: determining whether or not search information of the user is complete, if the search information of the user is incomplete, prompting the user to complete the search information, and if the search information of the user is complete, extracting key information according to the search information, calling corresponding service to search, and providing a search result to the user.

8. A system for information search, comprising:
an information receiving module, which is configured to receive an information search string inputted by a user;
an information completing module, which is configured to determine whether or not the information search string inputted by the user is complete, if the information search string inputted by the user is incomplete, helping the user in completing the information search string; and
an information searching module, which is configured to perform a search on the basis of a completed information search string.

9. The system for information search according to claim 8, wherein, when the information completing module helping the user in completing the information search string, helping the user in completing the information search string by means of user context and/or user scenario.

10. The system for information search according to claim 9, wherein the user context comprises user search histories, user search records and related search records to similar information of other users; wherein the user scenario comprises a location of the user, time, and/or user interest.

11. The system for information search according to claim 9, the system further comprising: an information determining module, which is configured to determine whether or not the information search string inputted by the user is complete, if the information search string inputted by the user is incomplete, helping the user in completing search information by the information completing module, and if the information search string inputted by the user is complete, extracting key information by the information extracting module.

12. The system for information search according to claim 9, the system further comprising: a database establishing module and an information distinguishing module, wherein the database establishing module is configured to establish a database of search field, wherein the information distinguishing module is configured to distinguish a received information search string according to a task classifier.

13. The system for information search according to claim 12, wherein the database establishing module establishing the database is by: establishing keywords of different search fields; obtaining a common search corpus of a search task; and
extracting a common sentence pattern according to the search corpus.

14. The system for information search according to claim 9, the system further comprising: an information complement determining module, an information prompting module and an information extracting module, wherein the information complement determining module is configured to determine whether or not search information of the user is complete, if the search information of the user is incomplete, prompting the user to complete the search information by the information prompting module, and if the search information of the user is complete, extracting key information by the information extracting module; wherein the information prompting module is configured to prompt the user to complete the search information; wherein the information extracting module is configured to extract key information according to the search information.

15. A computer readable storage medium for storing computer and/or mobile terminal executable program, wherein the executable program is used for controlling the computer and/or mobile terminal to perform a method for information search, comprising:
receiving an information search string inputted by a user;
determining whether or not the information search string inputted by the user is complete, if the information search string inputted by the user is incomplete, then helping the user in completing the information search string; and
performing a search on the basis of a completed information search string.

16. The method for information search according to claim 3, before the step of receiving the information search string inputted by the user, the method further comprising: establishing a database of search field.

17. The method for information search according to claim 3, after the step of receiving the information search string inputted by the user, the method further comprising: distinguishing a received information search string according to a task classifier.

18. The system for information search according to claim 10, the system further comprising: an information determining module, which is configured to determine whether or not the information search string inputted by the user is complete, if the information search string inputted by the user is incomplete, helping the user in completing search information by the information completing module, and if the information search string inputted by the user is complete, extracting key information by the information extracting module.

19. The system for information search according to claim 10, the system further comprising: a database establishing module and an information distinguishing module, wherein the database establishing module is configured to establish a database of search field, wherein the information distinguishing module is configured to distinguish a received information search string according to a task classifier.

20. The system for information search according to claim 10, the system further comprising: an information complement determining module, an information prompting module and an information extracting module, wherein the information complement determining module is configured to determine whether or not search information of the user is complete, if the search information of the user is incomplete, prompting the user to complete the search information by the information prompting module, and if the search information of the user is complete, extracting key information by the information extracting module; wherein the information prompting module is configured to prompt the user to complete the search information; wherein the information extracting module is configured to extract key information according to the search information.
